(19) United States
(12) Patent Application Publication
(10) Pub. No.: US 2015/0319509 A1
(43) Pub. Date: Nov. 5, 2015

(54) MODIFIED SEARCH AND ADVERTISEMENTS FOR SECOND SCREEN DEVICES

(71) Applicant: Verizon Patent and Licensing Inc., Basking Ridge, NJ (US)

(72) Inventors: Jian Huang, Sudbury, MA (US); Gong Zhang, Waltham, MA (US); Jianxiu Hao, Acton, MA (US); Gaurav D. Mehta, Brookline, MA (US); Ishan Awasthi, Wilmington, MA (US)

(73) Assignee: Verizon Patent and Licensing Inc., Basking Ridge, NJ (US)

(21) Appl. No.: 14/268,695

(22) Filed: May 2, 2014

(51) Int. Cl. H04N 21/8405; G06F 17/30; H04N 21/4722; H04N 21/278; H04N 21/81; H04N 21/234; H04N 21/41; H04N 21/482

(52) U.S. Cl. CPC H04N 21/8405; H04N 21/4122; G06F 17/30823; H04N 21/4828; H04N 21/278; H04N 21/812; H04N 21/23424; H04N 21/4722; H04N 21/4126

(57) ABSTRACT

A method, performed by a computer device, may include receiving a search query from a second screen device and determining that a video asset is being streamed to a first screen device associated with the second screen device. The may further include modifying the search query based on one or more keywords associated with the video asset, based on determining that the video asset is being streamed to the first screen device; obtaining search results based on the modified search query; and providing the obtained search results to the second screen device.

### BACKGROUND INFORMATION

Video content may be available from many sources and may be delivered to users through a variety of methods. Video content may be delivered to users, for example, via a set top box, a computer device, a digital media device, or a wireless mobile device. A user may own or operate several devices which are able to present video content. For example, a user may own a television device with a large viewing screen. However, the television device may provide limited interactive features. Therefore, the user may use another device, such as a tablet or a smartphone, together with the television device, to enhance the viewing experience. The other device may be referred to as a second screen device.

### BRIEF DESCRIPTION OF THE DRAWINGS

FIG. 1 is a diagram illustrating an environment according to one or more implementations described herein;

FIG. 2 is a diagram illustrating exemplary components of the mobile device of FIG. 1;

FIG. 3 is a diagram illustrating exemplary components of a computer device that may be included in one or more of the devices of FIG. 1;

FIG. 4 is a diagram illustrating exemplary functional components of the mobile device of FIG. 1;

FIG. 5A is a diagram illustrating exemplary functional components of the search optimization system of FIG. 1;

FIG. 5B is a diagram illustrating exemplary components that may be stored in the video asset database of FIG. 5A;

FIG. 6 is a flowchart for determining keywords and advertisements for a video asset according to one or more implementations described herein;

FIG. 7 is a flowchart for modifying a search for a second screen device according to one or more implementations described herein;

FIG. 8 is a flowchart for processing a search request by a second screen device, while a video asset is being streamed to a first screen device, according to one or more implementations described herein;

FIG. 9 is a flowchart for processing a message composition by a second screen device, while a video asset is being streamed to a first screen device, according to one or more implementations described herein;

FIG. 10 is a diagram of an exemplary user interface according to one or more implementations described herein;

FIG. 11 is a diagram of a first exemplary scenario according to one or more implementations described herein;

FIG. 12 is a diagram of a second exemplary scenario according to one or more implementations described herein;

FIG. 13 is a diagram of a third exemplary scenario according to one or more implementations described herein; and

FIG. 14 is a diagram of a fourth exemplary scenario according to one or more implementations described herein.

### DETAILED DESCRIPTION OF PREFERRED EMBODIMENTS

The following detailed description refers to the accompanying drawings. The same reference numbers in different drawings identify the same or similar elements.

Implementations described herein relate modified search and advertisements for second screen devices. A user may initiate streaming of a video asset to a device with a large viewing screen (e.g. a television), referred to herein as a first screen device. While the video asset is being streamed to the first screen device, the user may use a device with a small viewing screen (e.g., a smart phone, a tablet computer, etc.), referred to herein as a second screen device. The user may perform activities on the second screen device that are related to the video asset being streamed to the first screen device. For example, the user may use the second screen device to perform a search related to the video asset or may compose a message relating to the video asset.

The second screen device may detect that a video asset is being streamed, or being broadcasted, to the first screen device. In some implementations, the user may initiate streaming of the video asset using the second screen device and may transfer the streaming to the first screen device. As an example, the video asset may only be accessible to the user via the second screen device and the second screen device may perform digital rights management (DRM) and/or decoding of the video asset while the video asset is being streamed to the first screen device. As another example, the user may navigate to a particular content provider's web site using the second screen device and may make a selection of a video asset. The content provider may initiate streaming to the first screen device based on a configuration associated with the user's account. Thus, if the user initiates streaming of the video asset with the second screen device, the second screen device may retain information identifying the video asset being streamed to the first screen device.

In other implementations, the second screen device may obtain information identifying the video asset being streamed, or being broadcasted, to the first screen device using another technique. For example, the first screen device and the second screen device may pair up via a WiFi connection, a Bluetooth connection, a Near Field Communication (NFC), and/or another type of wireless connection. After pairing up, the first screen device may send information identifying the video asset to the second screen device. In yet other implementations, the second screen device may detect that a video asset is being played by the first screen device. For example, the second screen device may detect audio signals being played by the first screen device (e.g., by a television playing in a public space, such as a waiting room), may capture an audio sample, and may use the captured audio sample to identify a video asset being played by the first screen device.

The second screen device may receive a request to execute a search query. For example, the user may activate a browser application or a search bar on the second screen device and may enter a search query. The second screen device may modify the search query based on detecting that the video asset is being streamed to the first screen device, may obtain search results from a search engine based on the modified search query, and may present the obtained search results on the second screen of the second screen device.

The search query may be modified in a number of different ways. As an example, the second screen device may add information identifying the video asset, being streamed to the first screen device, to the search query. The information identifying the video asset may be used by a search engine to refine the search query and/or to modify the search results. In some implementations, the information identifying the video asset may include information identifying a particular video segment being streamed and the search query and/or search results may be refined based on the particular video segment. As another example, the user may be prompted to indicate whether the search query is related to the video asset.

As yet another example, the second screen device may obtain a list of keywords associated with the video asset from a search optimization system and may present at least some of the keywords from the list to the user via the second screen. The user may select one or more of the presented keywords and the presented keywords may be added to the search query. As yet another example, the second screen device may obtain one or more keywords from the first screen device and/or from another device associated with the video asset, such as a metadata server that stores metadata associated with the video asset, and may add the obtained keywords to the search query.

The search query may be sent to a search optimization system. The search optimization system may determine that a video asset is being streamed to a first screen device, associated with the second screen device from which the search query was received. The search optimization system may modify the search query based on one or more keywords associated with the video asset. For example, if the user selected one or more keywords associated with the video asset, the search optimization system may add the selected keywords to the search query. As another example, the search optimization system may select a particular meaning for a keyword in the search query based on the video asset. As another example, the search optimization system may refine a keyword based on the video asset. Moreover, the search query may be refined based on a particular video segment currently being streamed to the first screen device. For example, different keywords may be associated with different video segments of the video asset.

The search optimization system may request search results from a search engine using the modified search query. In some implementations, the search engine may be part of the search optimization system. In other implementations, the search engine may be separate and/or remote from the search optimization system and/or may be managed by a different entity. In some implementations, alternatively or additionally to modifying the search query, the search optimization system may receive the search results from the search engine and may modify the search results based on the video asset. As an example, the search optimization system may submit an unmodified search query to the search engine, may obtain search results from the search engine, and may modify the search results based on one or more keywords associated with the video asset. For example, the search results may be re-ordered based on relevance to one or more keywords associated with the video asset. The search optimization system may provide the search results to the second screen device. Furthermore, the search optimization system may select one or more advertisements based on the modified search query and may provide the selected advertisements to the second screen device in connection with the search results.

Keywords associated with a video asset and used to modify a search query and/or search results associated with a second screen device may be selected based on metadata associated with the video asset, based on historical search queries associated with the video asset, based on content of web pages associated with the video asset, based on content extracted from the video asset, based on keywords manually entered and associated with the video asset, and/or based on other techniques and/or sources of keywords.

Implementations described herein further relate to modifying auto-completion and/or auto-correction of messages being composed on a second screen device based on a video asset being streamed to a first screen device. The second screen device may detect activation of a message composition interface after detecting that a video asset is being streamed to a first screen device associated with the second screen device. The message composition interface may be used to generate a Short Message Service (SMS) message, an email message, a social media website message, and/or a different type of message. The second screen device may obtain a list of keywords associated with the video asset and may update an auto-completion dictionary associated with the message composition interface. For example, keywords associated with the video asset may be given preference in the auto-completion dictionary while the video asset is being streamed to the first screen device.

The phrase “video asset,” as used herein, may include Video On Demand (VOD) content, pay-per-view (PPV) video content, rented video content, live broadcasts, free television content (e.g., from free television broadcasters, etc.), paid for television content (e.g., from pay television content providers), on-line video content (e.g., on-line television programs, movies, videos, etc.), advertising, games, music videos, promotional information (e.g., such as previews, trailers, etc.), etc.

The phrase “search query,” as the term is used herein, may include any string of characters, such as words, phrases, and/or structured data, which may be used to retrieve one or more search results relevant to the search query. Additionally or alternatively, a search query may include audio input, such as spoken language, images, Global Position System (GPS) coordinates, and/or automated search query data generated from a user's location, preferences, and/or actions. Furthermore, the term “keyword” may refer to a single word or to a phrase that includes multiple words.

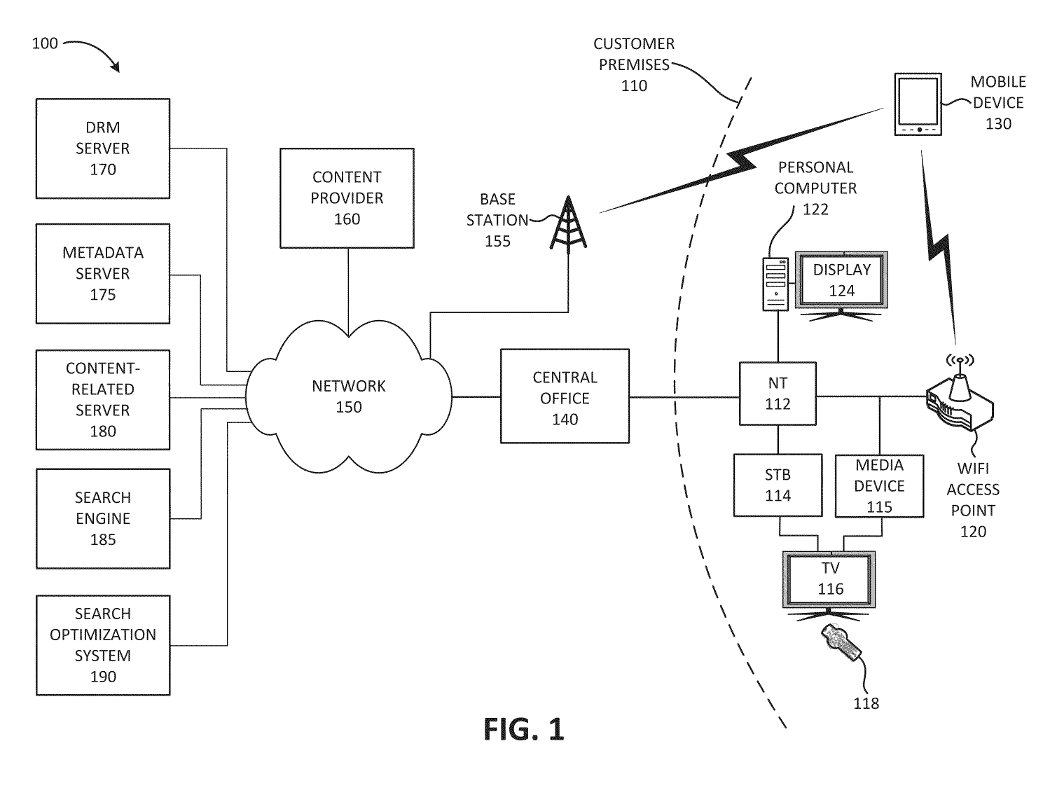

FIG. 1 is a diagram of an exemplary environment 100 in which the systems and/or methods, described herein, may be implemented. As shown in FIG. 1, environment 100 may include a customer premises 110, a central office 140, a network 150, a content provider 160, a digital rights management (DRM) server 170, a metadata server 175, a content-related server 180, a search engine 185, and a search optimization system 190.

Customer premises 110 may include a particular location (or multiple locations) associated with a customer. For example, customer premises 110 may include the customer's home, a customer's work location, etc. Customer premises 110 may include a network terminal (NT) 112, a set top box (STB) 114, a media device 115, a television 116, a remote control 118, a WiFi access point (AP) 120, a personal computer 122, a display 124, and a mobile device 130.

NT 112 may receive content from central office 140 via a connection, such as, for example, a fiber optic cable connection, a coaxial cable connection, a wireless connection, and/or another type of connection. Furthermore, NT 112 may send information from a device associated with customer premises 110 to central office 140. In one implementation, NT 112 may include an optical network terminal and NT 112 and central office 140 may form part of a high-speed fiber optic network. In another implementation, NT 112 may include a cable modem. In yet another implementation, NT 112 may include a fixed wireless transceiver, a WiFi access point, and/or a Bluetooth device. Additionally or alternatively, NT 112 may include a layer 2 and/or layer 3 network device, such as a switch, router, firewall, and/or gateway. Customer premises 110 may receive one or more services via the connection between NT 112 and central office 140, such as, for example, a television service, Internet service, and/or voice communication (e.g., telephone) service.

STB 114 may receive content and output the content to television 116 for display. STB 114 may include a component (e.g., a cable card or a software application) that interfaces with (e.g., plugs into) a host device (e.g., a personal computer, television 116, a stereo system, etc.) and allows the host device to display content. STB 114 may also be implemented as a home theater personal computer (HTPC), an optical disk player (e.g., digital video disk (DVD) or Blu-Ray™ disc player), a cable card, etc. STB 114 may receive commands and/or other type of data from other devices, such as remote control 118, and may transmit the data to other devices in environment 100.

Media device 115 may include a digital media player (e.g., Apple TV, Google Chromecast, Amazon Fire TV, etc.) configured to stream digital media files (e.g., video files, audio files, images, etc.) from personal computer 122, mobile device 130, NT 112, and/or a storage device via WiFi access point 120. Media device 115 may include smart television features that enable media device 115 to support add-on applications. In some implementations, media device 115 may correspond to a gaming system (e.g., Microsoft XBOX, Sony Playstation, etc.).

Television 116 may output content received from STB 114 and/or from media device 115. Television 116 may include speakers as well as a display. Remote control 118 may issue wired or wireless commands for controlling other electronic devices, such as television 116, media device 115, and/or STB 114. Remote control 118, in conjunction with television 116, media device 115, and/or STB 114, may allow a customer to interact with an application running on television 116, media device 115, and/or STB 114. Other types of devices (e.g., a keyboard, mouse, mobile phone, etc.) may be used instead of, or in addition to, remote control 118, in order to control television 116, media device 115, and/or STB 114. STB 114 may also include speech recognition software that processes voice commands. STB 114, media device 115, television 116, personal computer 122, and/or display 124 may function as a first screen device with respect to mobile device 130.

WiFi AP 120 may be configured to enable wireless devices in customer premises 110 to communicate with each other. For example, WiFi AP 120 may be configured to use IEEE 802.11 standards for implementing a wireless LAN network. WiFi AP 120 may enable mobile device 130 and/or other devices to communicate with each other and/or with NT 112. Personal computer 122 may include a desktop computer, a laptop computer, a tablet computer, and/or another type of computation and/or communication device. Personal computer 122 may include a microphone to capture audio and/or a camera to capture images or video. Personal computer 122 may include display 124 for displaying images and/or video content received from STB 114. Personal computer 122 may also include a speaker for playing audio signals.

Mobile device 130 may include a portable communication device (e.g., a mobile phone, a smart phone, a phablet device, a wearable computer device (e.g., a glasses smartphone device, a wristwatch smartphone device, etc.), global positioning system (GPS) device, and/or another type of wireless device); a laptop, tablet, or another type of portable computer; a media playing device; a portable gaming system; and/or any other type of mobile computer device with communication and output capabilities. Mobile device 130 may function as a second screen device with respect to STB 114, media device 115, television 116, personal computer 122, and/or display 124.

Central office 140 may include one or more devices, such as computer devices and/or server devices, which ingest content, store content, format content, and/or deliver content to customer premises 110. For example, central office 140 may provide television channels and/or other type of content from a video content delivery system, such as content provider 160. Furthermore, central office 140 may provide a connection service to network 150 for customer premises 110.

Network 150 may include one or more circuit-switched networks and/or packet-switched networks. For example, network 150 may include a local area network (LAN), a wide area network (WAN), a metropolitan area network (MAN), a Public Switched Telephone Network (PSTN), an ad hoc network, an intranet, the Internet, a fiber optic-based network, a wireless network, and/or a combination of these or other types of networks. Network 150 may include base station 155. Base station 155 may function as a base station that enables wireless devices in customer premises 110, such as mobile device 130, to communicate with network 150. For example, base station 155 may include a Long Term Evolution eNodeB base station, a Global System for Mobile Communications (GSM) base station, a Code Division Multiple Access (CDMA) base station, and/or another type of base station.

Content provider 160 may include one or more devices, such as computer devices and/or server devices, which are configured to provide video content to customer premises 110. For example, content provider 160 may include free television broadcast providers (e.g., local broadcast providers, such as NBC, CBS, ABC, and/or Fox), for-pay television broadcast providers (e.g., TNT, ESPN, HBO, Cinemax, CNN, etc.), and/or Internet-based content providers (e.g., Youtube, Vimeo, Netflix, Hulu, Veoh, etc.) that stream content from web sites and/or permit content to be downloaded (e.g., via progressive download, etc.). Content provider 160 may include on-demand content providers (e.g., video on demand (VOD), pay per view (PPV), etc.).

DRM server 170 may include one or more devices, such as computer devices and/or server devices, which are configured to provide DRM for content provider 160. For example, a video asset may be streamed from content provider 160 to television 116, while DRM keys are validated between DRM server 170 and mobile device 130.

Metadata server 175 may include one or more devices, such as computer devices and/or server devices, which store metadata associated with a video asset stored in connection with content provider 160. The metadata may, for example, include an identifier associated with a video asset (e.g., a number, a name, a title, etc.); a genre of the video asset (e.g., horror, comedy, adult, etc.); a category of the video asset (e.g., VOD asset, a PPV asset, an on-line asset, etc.); a text description, a key word index, and/or summary of the video asset; an image (e.g., cover art) associated with the video asset; information associated with artists associated with the video asset (e.g., names of actors, directors, producers, etc.); information associated with a type of video asset (e.g., a movie, music video, a game, etc.); a rating associated with the video asset (e.g., general audience (G), parental guidance (PG), PG-13, restricted (R), mature audience (MA), etc.); user reviews associated with the video asset; and/or other types of information associated with the video asset.

Content-related server 180 may include one or more devices, such as computer devices and/or server devices, which store content related to a video asset hosted by content provider 160. For example, content-related server 180 may store a web page associated with a video asset (e.g., an information page about the video asset, a page with a review of the video asset, a blog post about the video asset, etc.). Web pages stored by content-related server 180 may be crawled to obtain keywords associated with a video asset.

Search engine 185 may include one or more devices, such as computer devices and/or server devices, which receive a search query from a requesting device (e.g., mobile device 130, search optimization system 190, etc.), search one or more document indices to identify documents matching the received search query, rank the identified documents, and provide a ranked list of identified documents to the requesting device.

Search optimization system 190 may include one or more devices, such as computer devices and/or server devices, which perform search modification and advertisement selection for a second screen device. For example, search optimization system 190 may receive a search query from mobile device 130 and may determine that mobile device 130 is associated with a video asset being streamed to television 116 (or to display 124). Search optimization system 190 may modify the search query based on one or more keywords associated with the video asset and/or may modify search results, obtained for the search query from search engine 185, based on the one or more keywords associated with the video asset. In some implementations, search optimization system 190 may be part of search engine 185. In other implementations, search optimization system 190 may be separate and/or remote from search engine 180 and may be operated by a different entity than search engine 180.

Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

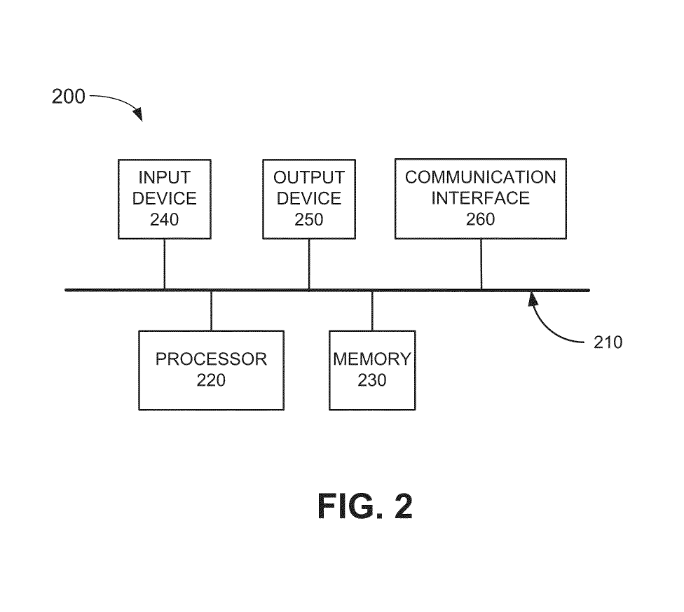

FIG. 2 is a diagram illustrating exemplary functional components of device 200 according to an implementation described herein. Content provider 160, DRM server 170, metadata server 175, content-related server 180, search engine 185, search optimization system 190, STB 114, media device 115, and/or other devices in environment 100 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to modification of search and advertisement selection for a second screen device, associated with a video asset being streamed to a first screen device. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than those depicted in FIG. 2. Additionally or alternatively, one or more components of device 200 may perform one or more tasks described as being performed by one or more other components of device 200.

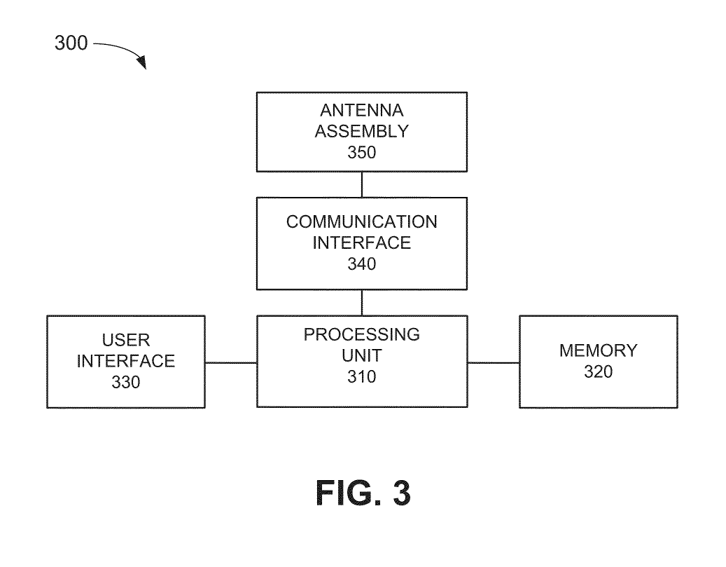

FIG. 3 is a diagram illustrating exemplary components of mobile device 130 according to an implementation described herein. As shown in FIG. 3, mobile device 130 may include a processing unit 310, a memory 320, a user interface 330, a communication interface 340, and an antenna assembly 350.

Processing unit 310 may include one or more processors, microprocessors, application specific integrated circuits (ASICs), field programmable gate arrays (FPGAs), and/or other processing logic. Processing unit 310 may control operation of mobile device 130 and its components.

Memory 320 may include a random access memory (RAM) or another type of dynamic storage device, a read only memory (ROM) or another type of static storage device, a removable memory card, and/or another type of memory to store data and instructions that may be used by processing unit 310.

User interface 330 may allow a user to input information to mobile device 130 and/or to output information from mobile device 130. Examples of user interface 330 may include a speaker to receive electrical signals and output audio signals; a camera to receive image and/or video signals and output electrical signals; a microphone to receive sounds and output electrical signals; buttons (e.g., a joystick, control buttons, a keyboard, or keys of a keypad) and/or a touchscreen to receive control commands; a display, such as an LCD, to output visual information; an actuator to cause device 300 to vibrate; a sensor; and/or any other type of input or output device.

Communication interface 340 may include a transceiver that enables mobile device 130 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 340 may include a transmitter that converts baseband signals to radio frequency (RF) signals and/or a receiver that converts RF signals to baseband signals. Communication interface 340 may be coupled to antenna assembly 350 for transmitting and receiving RF signals.

Communication interface 340 may include a logical component that includes input and/or output ports, input and/or output systems, and/or other input and output components that facilitate the transmission of data to other devices. For example, communication interface 340 may include a network interface card (e.g., Ethernet card) for wired communications and/or a wireless network interface (e.g., a WiFi) card for wireless communications. Communication interface 340 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

Antenna assembly 350 may include one or more antennas to transmit and/or receive RF signals. Antenna assembly 350 may, for example, receive RF signals from communication interface 340 and transmit the signals via an antenna and receive RF signals from an antenna and provide them to communication interface 340.

As described herein, mobile device 130 may perform certain operations in response to processing unit 310 executing software instructions contained in a computer-readable medium, such as memory 320. A computer-readable medium may be defined as a non-transitory memory device. A non-transitory memory device may include memory space within a single physical memory device or spread across multiple physical memory devices. The software instructions may be read into memory 320 from another computer-readable medium or from another device via communication interface 340. The software instructions contained in memory 320 may cause processing unit 310 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of mobile device 130, in other implementations, mobile device 130 may include fewer components, different components, differently arranged components, or additional components than those depicted in FIG. 3. Additionally or alternatively, one or more components of mobile device 130 may perform the tasks described as being performed by one or more other components of mobile device 130.

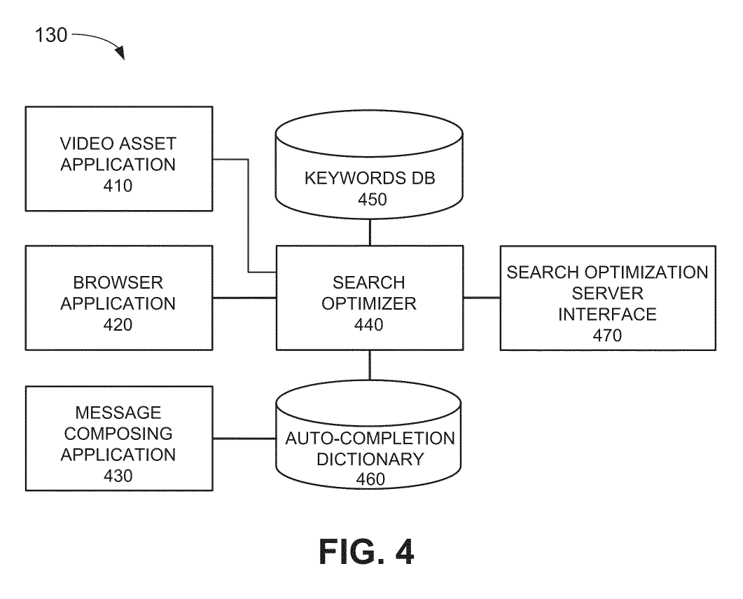

FIG. 4 is a diagram illustrating exemplary functional components of mobile device 130 according to an implementation described herein. The functional components of mobile device 130 may be implemented, for example, via processing unit 310 executing instructions from memory 320. Alternatively, some or all of the functional components of mobile device 130 may be implemented via hard-wired circuitry.

As shown in FIG. 4, mobile device 130 may include a video asset application 410, a browser application 420, a message composing application 430, a search optimizer 440, a keywords database (DB) 450, an auto-completion dictionary 460, and a search optimization server interface 470.

Video asset application 410 may include a media player application configured to receive streaming video data and to display the streaming video data on display device (e.g., touchscreen) of mobile device 130. Furthermore, video asset application 410 may transfer streaming of a video asset to another device, such as STB 114, media device 115, and/or personal computer 122. Video asset application 410 may also be configured to perform DRM processing for a video asset and/or may perform decoding of the video asset based on a particular codec. Video asset application 410 may inform search optimizer 440 that a video asset is being streamed to another device.

Browser application 420 may include an application configured to browse the Internet and to display web pages to which the user has navigated. Furthermore, browser application 420 may receive a search query from the user, may send the search query to search engine 185 and/or search optimization system 190, may receive search results, and may display the search results.

Message composing application 430 may include an application and/or another type of software element to compose a message. For example, message composing application 430 may include, or be part of, an SMS application, an email application, a social media application, and/or another type of message compositing application. Message composing application 430 may access auto-completion dictionary 460 to auto-complete and/or auto-correct words entered by the user into a message composing interface generated by message composing application 430.

Search optimizer 440 may optimize a search based on a video asset being streamed to a first screen device (e.g., STB 114, media device 115, television 116, personal computer 122, and/or display 124). As an example, search optimizer 440 may add information identifying the video asset to a search query entered by the user before the search query is sent to search optimization system 190. As another example, search optimizer 440 may obtain keywords associated with the video asset from content provider 160, metadata server 175, search engine 185, and/or search optimization system 190 and may store the obtained keywords in keywords DB 450. Search optimizer 440 may provide the keywords stored in keywords DB 450 to the user and the user may select one or more of the keywords to add to the search query. Furthermore, search optimizer 440 may provide the obtained keywords to auto-completion dictionary 460.

Auto-completion dictionary 460 may include words that may be used by message composing application 430 to auto-complete and/or auto-correct words entered by the user using message composing application 430. Keywords associated with the video asset may be given preference in auto-completion dictionary 460 by message composing application 430 while the video asset is being streamed to the first screen device.

Search optimization server interface 470 may communicate with search optimization system 190. For example, search optimization server interface 470 may send a search query to search optimization system 190 and/or may receive search results from search optimization system 190 and may provide the search results to search optimizer 440.

Although FIG. 4 shows exemplary functional components of mobile device 130, in other implementations, mobile device 130 may include fewer functional components, different functional components, differently arranged functional components, or additional functional components than those depicted in FIG. 4. Additionally or alternatively, one or more functional components of mobile device 130 may perform functions described as being performed by one or more other functional components of mobile device 130.

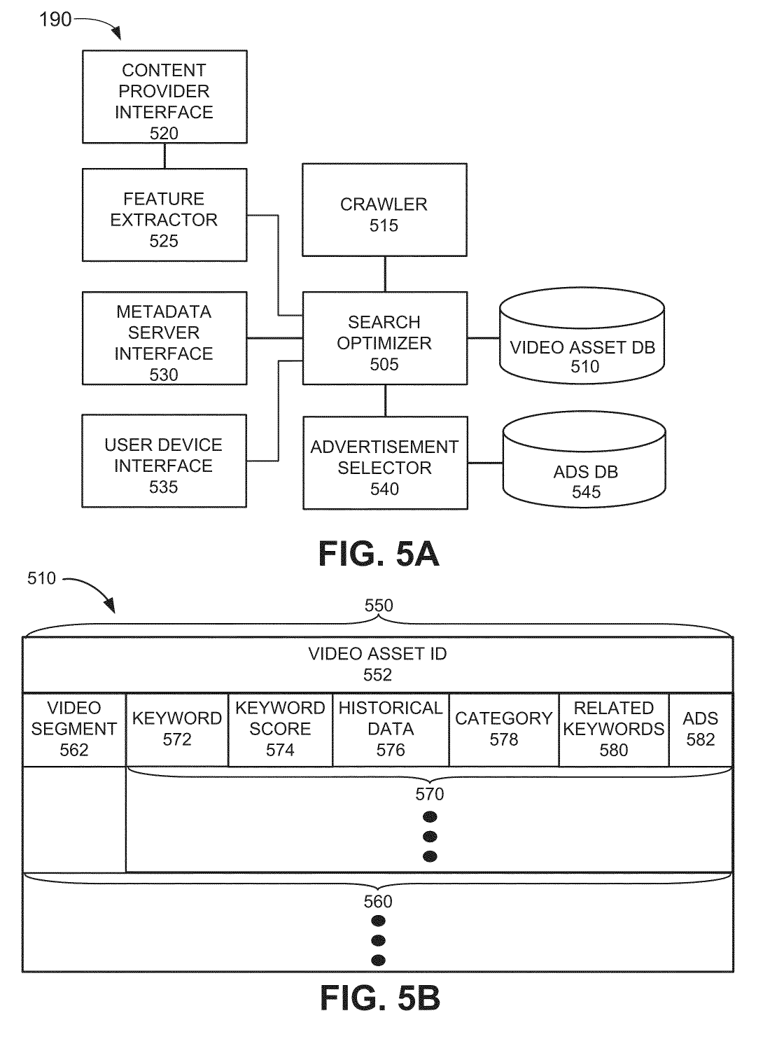

FIG. 5A is a diagram illustrating exemplary functional components of search optimization system 190 according to an implementation described herein. The functional components of search optimization system 190 may be implemented, for example, via processor 220 executing instructions from memory 230. Alternatively, some or all of the functional components of search optimization system 190 may be implemented via hard-wired circuitry.

As shown in FIG. 5A, search optimization system 190 may include a search optimizer 505, a video asset DB 510, a crawler 515, a content provider interface 520, a feature extractor 525, a metadata server interface 530, a user device interface 535, an advertisement selector 540, and an advertisements (ads) DB 545.

Search optimizer 505 may optimize a search based on a video asset being streamed to a first screen device. As an example, search optimizer 505 may modify a search query received from mobile device 130 based on keywords associated with the video asset before sending the search query to search engine 185. As another example, search optimizer 505 may submit a search query to search engine 185, may receive search results from search engine 185, and may modify the search results based on relevance to the keywords associated with the video asset. As yet another example, search optimizer 505 may provide a list of keywords associated with the video asset to mobile device 130, may receive a selection of one or more keywords from the mobile device 130, and may modify the search query based on the selection.

Video asset DB 510 may store information relating to particular video assets. Exemplary information that may be stored in video asset DB 510 is described below with reference to FIG. 5B.

Crawler 515 may crawl web sites related to the video asset (e.g., content-related server 180), such as information pages about the video asset, pages with reviews of the video asset, blog posts about the video asset, and/or other types of web pages, in order to determine keywords associated with the video asset. Crawler 515 may provide the determined keywords to search optimizer 505 to store in video asset DB 510.

Content provider interface 520 may communicate with content provider 160 to retrieve a video asset and provide the video asset to feature extractor 525. Feature extractor 525 may extract features from the video asset in order to determine keywords associated with the video asset. As an example, feature extractor 525 may extract closed captioning data and may analyze the closed captioning data to determine keywords associated with the video asset. As another example, feature extractor 525 may extract the audio data of the video asset and may perform speech recognition on the audio data to determine keywords associated with the video asset. As yet another example, feature extractor 525 may perform edge detection and/or object recognition analysis on the video data to identify objects in the video asset and may determine keywords associated with the video asset based on the identified objects.

Metadata server interface 530 may communicate with metadata server 175 to obtain metadata associated with the video asset. User device interface 535 may communicate with mobile device 130 to receive a search query from mobile device 130 and to provide search results and/or targeted advertisements to mobile device 130 in response to a search query.

Advertisement selector 540 may select one or more advertisements based on one or more keywords associated with a video asset being streamed to a first screen device and may provide the selected advertisements to be sent to a second screen device (e.g., mobile device 130). Ads DB 545 may store advertisements that may be selected by advertisement selector 540.

Although FIG. 5A shows exemplary functional components of search optimization system 190, in other implementations, search optimization system 190 may include fewer functional components, different functional components, differently arranged functional components, or additional functional components than those depicted in FIG. 5A. Additionally or alternatively, one or more functional components of search optimization system 190 may perform functions described as being performed by one or more other functional components of search optimization system 190.

FIG. 5B is a diagram illustrating exemplary components that may be stored in the video asset DB 510. As shown in FIG. 5B, video asset DB 510 may include one or more video asset records 550. Each video asset record 550 may store information relating a particular video asset. Video asset record 550 may include a video asset ID field 552 and one or more video segment field 560. Video asset ID field 552 may store information identifying a particular video asset, such as a name of the video asset, a catalog number of the video asset, a serial number of the video asset, and/or another type of video asset identifier.

Each video segment field 560 stores information relating to a particular video segment of the particular video asset. Video segment field 560 may include a segment field 562 and one or more keyword fields 570. Segment field 562 may store information identifying a particular video segment. For example, segment field 562 may identify a segment number, a start time and an end time for the video segment, and/or another video segment identifier. Each keyword field 570 may include information associated with a particular keyword associated with the particular video segment.

Keyword field 570 may include a keyword field 572, a keyword score field 574, a historical data field 576, a category field 578, a related keywords field 580, and an advertisements (ads) field 582. Keyword field 752 may include the particular keyword. Furthermore, keyword field 752 may include variations and/or common misspellings of the particular keyword. Keyword score field 754 may include a relevance score for the particular keyword. For example, different keywords associated with the particular video asset may have different relevance scores and more relevant keywords may be given preference when suggesting keywords to a user or when modifying search queries or search results based on keywords associated with a video asset.

Historical data field 576 may store historical data associated with the particular keyword. For example, the historical data may identify how often and/or under what conditions the particular keyword has been included in search queries by users for search queries that have been determined to be related to the particular video asset. Category field 578 may store information identifying one or more categories associated with the particular keyword. In some implementations, the category information may be hierarchical. For example, if the particular keyword corresponds to “Sherlock Holmes frock coat,” the category information may include an “objects/clothing/coat” categorization. Related keywords field 580 may include information identifying keywords related to the particular keyword. For example, if a user enters the particular keyword as part of a search query, the related keywords may be suggested to the user. The related keywords may be determined, for example, based on historical search data, based on the related keywords occurring together with the particular keyword in the video asset metadata or in content related to the video asset′ and/or based on another technique. Ads field 582 may identify one or more advertisements associated with the particular keyword.

Although FIG. 5B shows exemplary components of video asset DB 510, in other implementations, video asset DB 510 may include fewer components, different components, differently arranged components, or additional components than depicted in FIG. 5B.

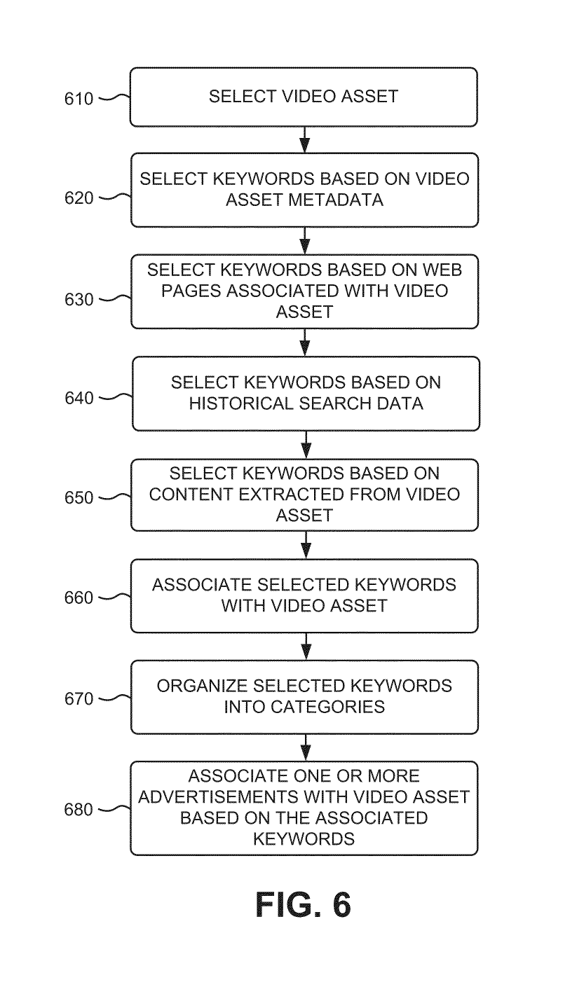

FIG. 6 is a flowchart for determining keywords and advertisements for a video asset according to one or more implementations described herein. In some implementations, the process of FIG. 6 may be performed by search optimization system 190. In other implementations, some or all of the process of FIG. 6 may be performed by another device or a group of devices separate from and/or including search optimization system 190.

The process of FIG. 6 may include selecting a video asset (block 610). For example, search optimizer 505 may select a video asset from video asset DB 510 for which keywords are to be determined. Keywords may be selected based on video asset metadata (block 620). For example, search optimizer 505 may communicate with metadata server 175 using metadata server interface 530 to obtain metadata for the video asset. Additionally or alternatively, metadata may be obtained from content provider 160.

The metadata may include, for example, a title of the video asset, a genre of the video asset, a category of the video asset, text description of the video asset, a plot synopsis of the video asset, people associated with the video asset (actors, directors, etc.), and/or other types of information associated with the video asset. Furthermore, the metadata may include information about the content of the video asset, such as information identifying characters, locations, historical events, quotes from the video asset, and/or other types of information about the content of the video asset. Moreover, the metadata may include information identifying products features in the video asset, such as, for example, information identifying food, clothing, vehicles, furniture, and/or other products used by people in the video asset. Different sets of metadata may be associated with different segments of the video asset. Keywords included in the video asset metadata may be selected and included in the video asset record 550 of the video asset.

Keywords based on web pages associated with the video asset may be selected (block 630). For example, crawler 515 may crawl content-related servers 180 to identify web pages associated with the video asset. Search optimizer 505 may extract keywords from the web pages using a variety of keyword extraction techniques. For example, search optimizer 505 may identify proper nouns in the web page, may identify nouns that are repeated at least a particular number of times, may identify highlighted, bolded, italicized, and/or hyperlinked terms, and/or may employ other techniques to identify keywords. Keywords extracted from web pages related to the video asset may be selected and included in the video asset record 550 of the video asset.

Keywords based on historical search data may be selected (block 640). For example, search optimizer 505 may analyze historical search data to identify search queries determined to be related to the video asset. A search query may be determined to be related to the video asset if the search query includes information identifying the video asset, if the search query includes keywords that are associated with the video asset, if the user clicks on returned search results that are related to the video asset, and/or based on another technique. Keywords included in search queries identified as related to the video asset may be selected and included in the video asset record 550 of the video asset.

Keywords based on content extracted from the video asset may be selected (block 650). Content provider interface 520 may obtain video asset data from content provider 160 and feature extractor 525 may extract content from the video asset data. For example, feature extractor 525 may extract closed captioning data and may analyze the closed captioning data to determine keywords associated with the video asset; may extract the audio data of the video asset and may perform speech recognition on the audio data to determine keywords associated with the video asset; may perform edge detection and/or object recognition analysis on the video data to identify objects in the video asset and may determine keywords associated with the video asset based on the identified objects; and/or may perform other techniques to extract content from the video asset data.

The selected keywords may be associated with the video asset (block 660) and the selected keywords may be organized into categories (block 670). For example, search optimizer 505 may store the extracted keywords in video asset record 550 of the video asset. Furthermore, search optimizer 505 may determine one or more categorizations for each selected keyword. For example, search optimizer 505 may access a search index that includes predetermined categorizations for keywords and may determine the categorizations based on the selected keywords based on information stored in the search index.

One or more advertisements may be associated with the video asset based on the associated keywords (block 680). For example, advertisement selector 540 may access ads DB 545 to determine advertisements associated with the selected keywords and may associate the determined advertisements in video asset DB 550 of the video asset.

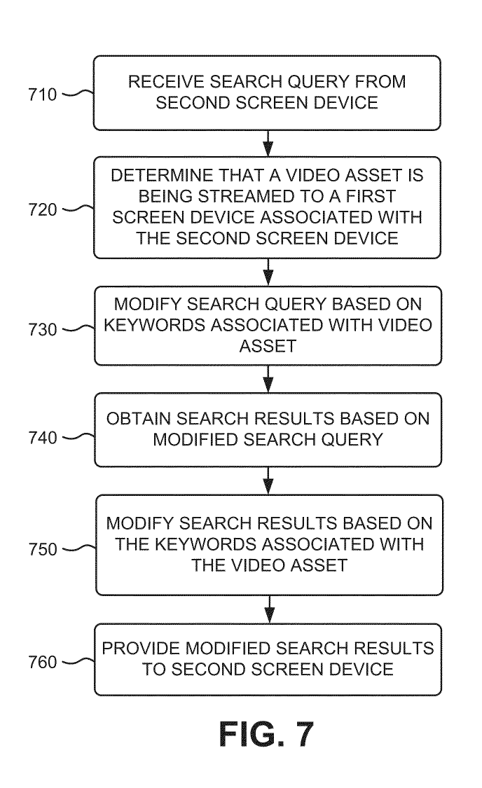

FIG. 7 is a flowchart for modifying a search for a second screen device according to one or more implementations described herein. In some implementations, the process of FIG. 7 may be performed by search optimization system 190. In other implementations, some or all of the process of FIG. 7 may be performed by another device or a group of devices separate from and/or including search optimization system 190.

The process of FIG. 7 may include receiving a search query from a second screen device (block 710). For example, a user may submit a search query to search optimization system 190 via mobile device 130 using browser application 420, while watching a streaming video asset on television 116. A determination may be made that a video asset is being streamed to a first screen device associated with the second screen device (block 720). As an example, the search query may include information identifying the video asset being streamed. For example, video asset application 410 may inform search optimizer 440 that a particular video asset is being streamed to a device associated with mobile device 130 and search optimizer 440 may include information identifying the particular video asset in search queries submitted by mobile device 130. As another example, STB 114 and/or media device 115 may send an indication to search optimization system 190 that a video asset is being streamed and search optimization system 190 may identify the indication as being associated with mobile device 130.

The search query may be modified based on keywords associated with the video asset (block 730). Search optimizer 505 may access video asset record 550 associated with the video asset to retrieve a list of keywords associated with the video asset. As an example, search optimizer 505 may provide a list of suggested keywords to mobile device 130, may receive a selection of one or more keywords from mobile device 130, and may add the selected one or more keywords to the search query. As yet another example, search optimizer 505 may give a higher weight to keywords that are determined to be related to the video asset.

As yet another example, search optimization system 190 may determine that a keyword in the search query is classified in multiple categories and may select a particular category (i.e., a particular meaning) for the keyword in the search query based on the video asset. For example, if the search query includes the keyword “Dakota,” and if the metadata associated with the video asset includes an actor with the name Dakota, the search optimization system may select a “name” categorization for the keyword, rather than a “place” categorization for the keyword. As another example, search optimization system 190 may refine a keyword based on the video asset. For example, if the search query includes the keyword “coat” and the video asset is associated with the keywords “Sherlock Holmes frock coat,” which are categorized in a “coat” category, the search optimization system may replace the keyword “coat” with the keywords “Sherlock Holmes frock coat.” Moreover, the search query may be refined based on a particular video segment currently being streamed to the first screen device. For example, different keywords may be associated with different video segments of the video asset. As another example, if the user is watching the movie “Sleepless in Seattle” and enters the search query “market”, the search query may be refined to “Seattle public market.”

Search results may be obtained based on the modified search query (block 740). For example, search optimization system 190 may request search results from search engine 185 using the modified search query. The search results may be modified based on the keywords associated with the video asset (block 750). In some implementations, alternatively or additionally to modifying the search query, search optimization system 190 may receive the search results from the search engine and may modify the search results based on the video asset. As an example, search optimization system 190 may submit an unmodified search query to search engine 185, may obtain search results from search engine 185, and may modify the search results based on one or more keywords associated with the video asset. For example, the search results may be re-ordered based on relevance to a keyword associated with the video asset.

The modified search results may be provided to the second screen device (block 760). For example, search optimization system 190 may provide the search results to mobile device 130. Furthermore, search optimization system 190 may select one or more advertisements based on the modified search query and may provide the selected advertisements to mobile device 130 in connection with the search results.

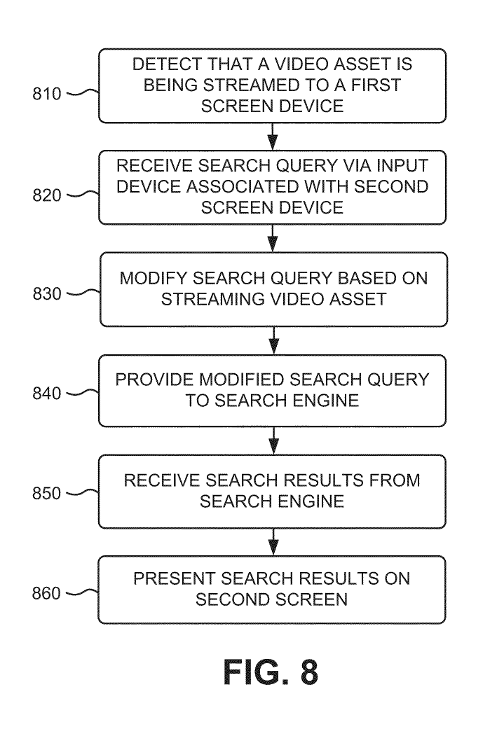

FIG. 8 is a flowchart for processing a search request by a second screen device, while a video asset is being streamed to a first screen device, according to one or more implementations described herein. In some implementations, the process of FIG. 8 may be performed by mobile device 130. In other implementations, some or all of the process of FIG. 8 may be performed by another device or a group of devices separate from and/or including mobile device 130.

The process of FIG. 8 may include detecting that a video asset is being streamed to a first screen device (block 810). As an example, the user may use video asset application 410 to request streaming of a video asset from content provider 160 to STB 114 or media device 115 and may provide information identifying the requested video asset to search optimizer 440. Additionally or alternatively, the first screen device (e.g., STB 114, media device 115, etc.) may inform mobile device 130 that the video asset is being streamed to the first screen device.

As another example, mobile device 130 may receive an indication from another device, such as content provider 160, that the video asset is being streamed to the first screen device. As yet another example, mobile device 130 may detect an audio signal of a video asset being played in the vicinity of mobile device (e.g., a public television) and may obtain an audio sample of the video asset being played.

A search query may be received via an input device associated with a second screen device (block 820). For example, the user may enter a search query using browser application 420 or using a search bar. The search query may be modified based on the streaming video asset (block 830). As an example, mobile device 130 may add information identifying the video asset, being streamed to the first screen device, to the search query. In some implementations, the information identifying the video asset may include information identifying a particular video segment being streamed. As another example, the user may be prompted to indicate whether the search query is related to the video asset. As yet another example, the second screen device may obtain a list of keywords associated with the video asset from search optimization system 190 and may present at least some of the keywords from the list to the user via the second screen. The user may select one or more of the presented keywords and the presented keywords may be added to the search query. As yet another example, mobile device 130 may obtain one or more keywords from the first screen device and/or from another device associated with the video asset, such as metadata server 175, and may add the obtained keywords to the search query and/or modify the search query based on the metadata.

The modified search query may be provided to a search engine (block 840) and search results may be received from the search engine (block 850) and presented on the second screen (block 860). For example, search optimizer 440 may provide the search query to search optimization system 190. Search optimization system 190 may return a set of search results and mobile device 130 may present the search results to the user on the screen of mobile device 130.

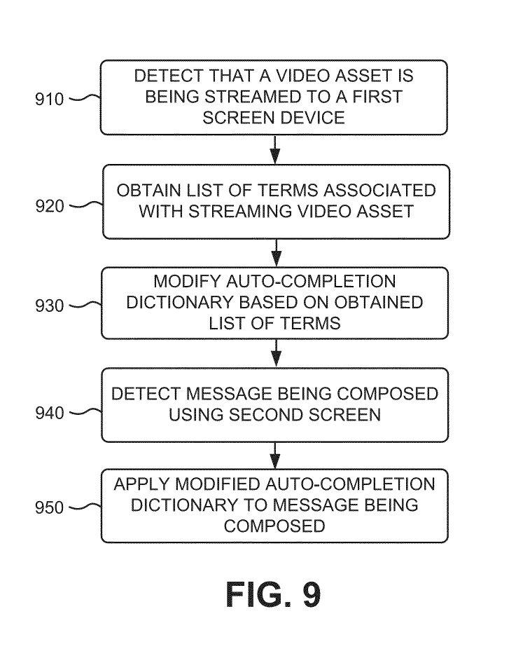

FIG. 9 is a flowchart for processing a message composition by a second screen device, while a video asset is being streamed to a first screen device, according to one or more implementations described herein. In some implementations, the process of FIG. 9 may be performed by mobile device 130. In other implementations, some or all of the process of FIG. 9 may be performed by another device or a group of devices separate from and/or including mobile device 130.

The process of FIG. 9 may include detecting that a video asset is being streamed to a first screen device (block 910). As an example, the user may use video asset application 410 to request streaming of a video asset from content provider 160 to STB 114 or media device 115 and may provide information identifying the requested video asset to search optimizer 440. Additionally or alternatively, the first screen device (e.g., STB 114, media device 115, etc.) may inform mobile device 130 that the video asset is being streamed to the first screen device.

As another example, mobile device 130 may receive an indication from another device, such as content provider 160, that the video asset is being streamed to the first screen device. As yet another example, mobile device 130 may detect an audio signal of a video asset being played in the vicinity of mobile device (e.g., a public television) and may obtain an audio sample of the video asset being played.

A list of terms associated with the streaming video asset may be obtained (block 920) and an auto-completion dictionary may be modified based on the obtained list of terms (block 930). For example, search optimizer 440 may request keywords associated with the video asset from search optimization system 190 in response to detecting that the video asset is being streamed to the first screen device. Search optimizer 440 of mobile device 130 may update auto-completion dictionary 460 with the received list of keywords and may give preference to the received list of keywords while the video is being streamed.

A message being composed may be detected (block 940) and the modified auto-completion dictionary may be applied to the message being composed (block 950). For example, the user may activate message composing application 430 to compose a message (e.g., an SMS application, an email application, a social media application, and/or another type of message compositing application). Message composing application 430 may use the modified auto-completion dictionary 460 to suggest terms for auto-completion and/or to auto-correct typing errors, while giving preference to terms associated with the video asset, while video asset is being streamed to the first screen device.

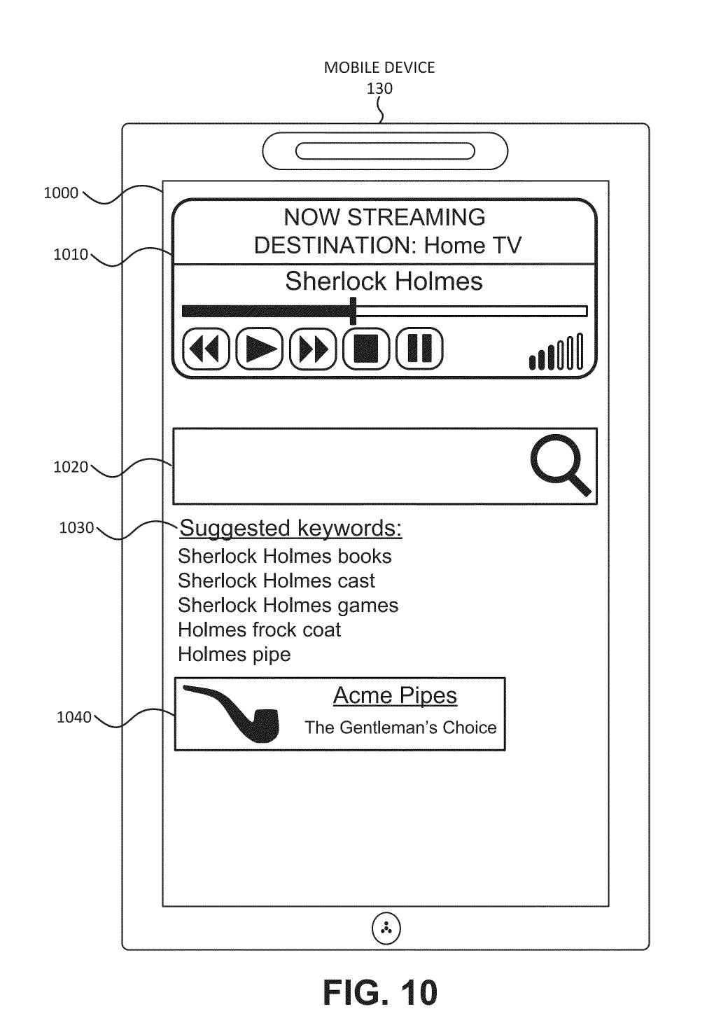

FIG. 10 is a diagram of an exemplary user interface 1000 according to one or more implementations described herein. User interface 1000 may be displayed by mobile device 130 after the user transfers streaming of a video asset to a first screen device. User interface 1000 may include a video asset application interface 1010, associated with video asset application 410, a search bar 1020, associated with browser application 420, a list of suggested keywords 1030, and an advertisement 1040.

Video asset application interface 1010 may include information identifying a video asset being streamed to another device and may include control buttons for controlling the streaming of the video asset. Search bar 1020 may enable a user to perform a search and to display search results in a browser window. The list of suggested keywords 1030 may be obtained from search optimization system 190 based on information identifying the video asset and may be displayed in response to the user activating search bar 1020. Additionally, search optimization system 190 may provide advertisement 1040 to mobile device 1030 and may instruct search optimizer 440 to display advertisement 1040 when search bar 1020 is activated by the user.

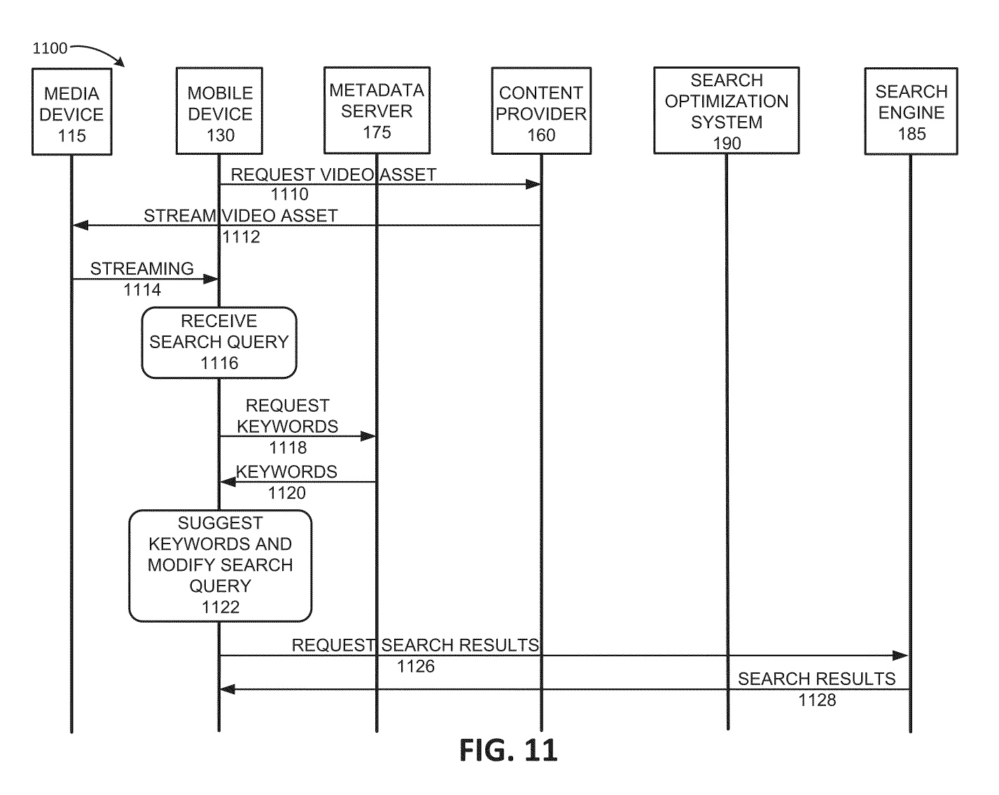

FIG. 11 is a diagram of a first exemplary scenario 1100 according to one or more implementations described herein. In scenario 1100, mobile device 130 obtains keywords for a video asset from metadata server 175 and displays a list of the keywords to the user when the user selects to perform a search. Scenario 1100 may include the user selecting to stream a video asset to media device 115 using mobile device 130. In response, mobile device 130 may send a request to stream the video asset to content provider 160 (signal 1110) and content provider 160 may begin to stream the video asset to media device 115 (signal 1112), which may display the streaming video asset on television 116 (not shown in FIG. 11). Media device 115 may send an indication to mobile 130 (or may continue to send indications at particular intervals) that the video asset is being streamed (signal 1114).

The user may enter a search query (e.g., by typing into search bar 1020) (block 1116). In response, mobile device 130 may request keywords related to the video asset from metadata server 175 (signal 1118) and metadata server 175 may send keywords related to the video asset to mobile device 130 (signal 1120). The keywords may include, for example, names of actors or actresses in a movie corresponding to the video asset.

Search optimizer 440 of mobile device 130 may display the received keywords as suggested keywords and the user may select a keyword to modify the search query (block 1122). For example, if the user was looking for information on an actor in a movie the user is watching via media device 115, the user may select the actor's name from the list of suggested keywords. Media device 130 may send the modified search query to search engine 185 (signal 1126) and may obtain search results corresponding to the modified search query from search engine 185 (signal 1128).

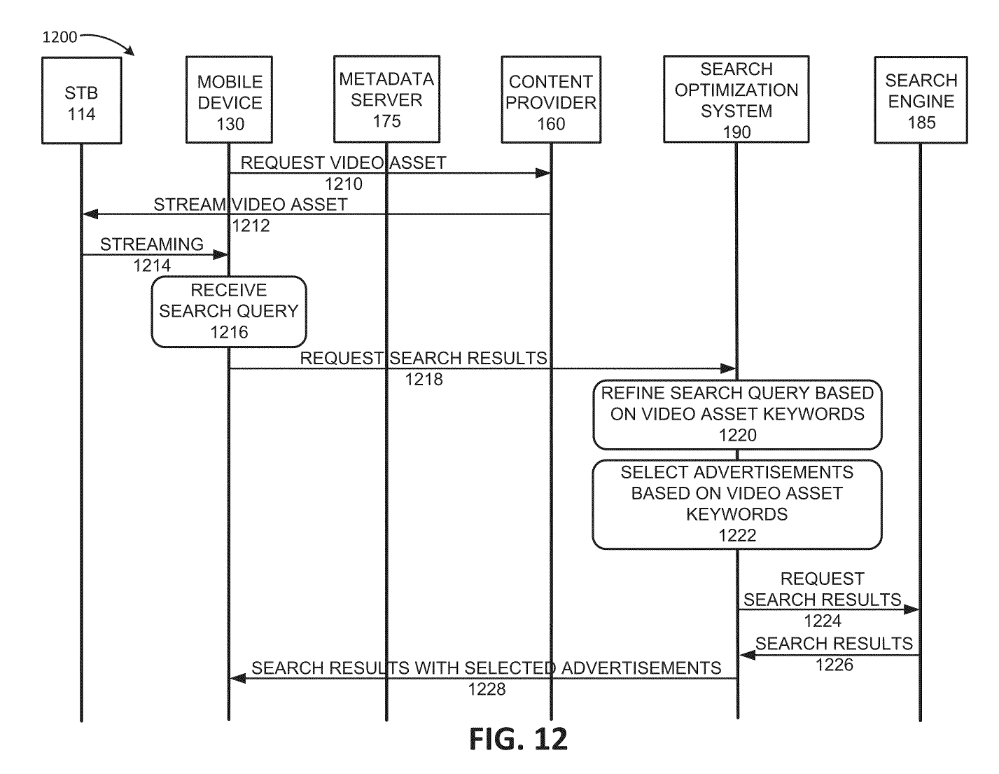

FIG. 12 is a diagram of a first exemplary scenario 1200 according to one or more implementations described herein. In scenario 1200, a search query from mobile device 130 may be refined by search optimization system 190 based on a video asset being streamed to STB 114 associated with mobile device 130. Scenario 1200 may include the user selecting to stream a video asset to STB 114 using mobile device 130. In response, mobile device 130 may send a request to stream the video asset to content provider 160 (signal 1210) and content provider 160 may begin to stream the video asset to STB 114 (signal 1212), which may display the streaming video asset on television 116 (not shown in FIG. 12). STB 114 may send an indication to mobile 130 (or may continue to send indications at particular intervals) that the video asset is being streamed (signal 1214).

The user may enter a search query (e.g., by typing into search bar 1020) (block 1216) and mobile device 130 may send the search query to search optimization system 190 to request search results (signal 1218). Search optimization system 190 may refine the search query based on video asset keywords (block 1220) and may also select advertisements based on the video asset keywords (block 1222). For example, the user may enter a search query “location Casablanca” while watching the movie Casablanca and search optimization system 190 may refine the search query by selecting a “film name” categorization for the term “Casablanca.” Additionally or alternatively, search optimization system 190 may determine that keywords under the categorization “location” are included in video asset record 550 for the film Casablanca in video asset DB 510 and may select a keyword identifying a location based on a current segment being streamed (e.g., the keyword “Paris”).

Search optimization system 190 may submit the refined search query to search engine 185 to request search results (signal 1224) and search engine 185 may return search results based on the received search query (signal 1226). Search optimization system 190 may provide the received search results, along with the selected advertisements, to mobile device 130 (signal 1228).

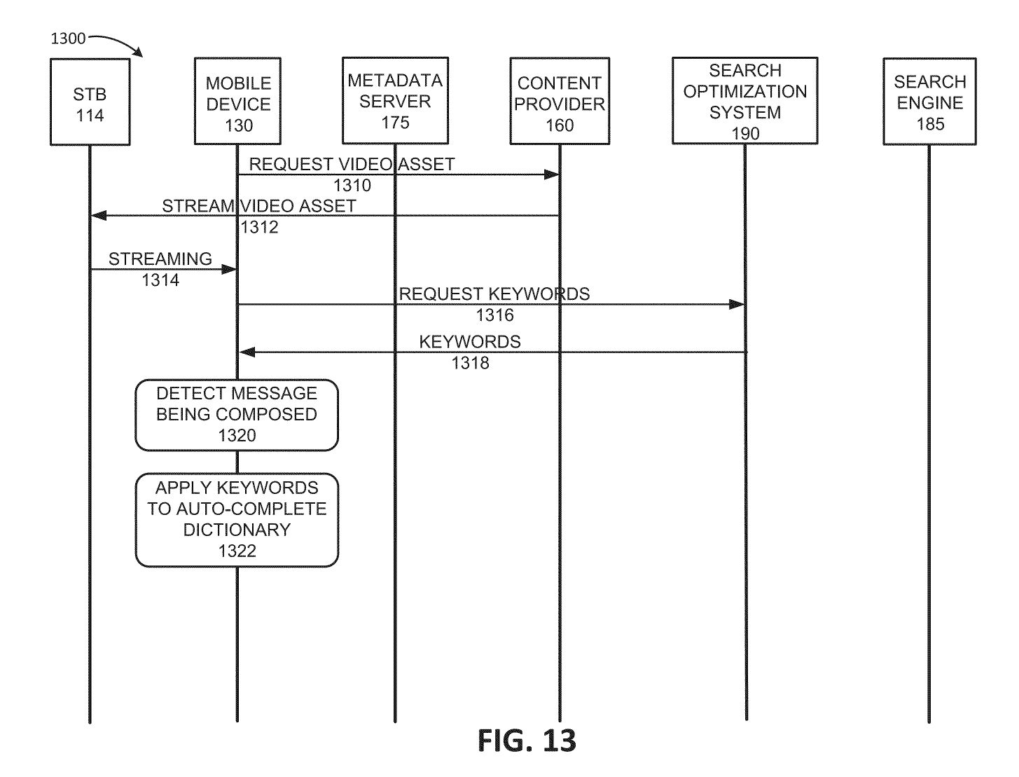

FIG. 13 is a diagram of a first exemplary scenario 1300 according to one or more implementations described herein. In scenario 1300, mobile device 130 may update an auto-completion dictionary based on a video asset being streamed to STB 114. Scenario 1300 may include the user selecting to stream a video asset to STB 114 using mobile device 130. In response, mobile device 130 may send a request to stream a movie to content provider 160 (signal 1310) and content provider 160 may begin to stream the movie to STB 114 (signal 1312), which may display the streaming movie on television 116 (not shown in FIG. 13). STB 114 may send an indication to mobile 130 (or may continue to send indications at particular intervals) that the movie is being streamed (signal 1314).

In response, search optimizer 440 may request keywords associated with the movie from search optimization system 190 (signal 1316) and search optimization system 190 may provide a list of keywords associated with the movie to mobile device 130 (signal 1318). Search optimizer 440 of mobile device 130 may update auto-completion dictionary 460 with the received list of keywords and may give preference to the received list of keywords while the movie is being streamed. The user may activate message composing application 430 to compose an SMS message to a friend watching the same movie and search optimizer 440 may detect that the message is being composed (block 1320) and the received keywords may be applied to the auto-complete dictionary (block 1322). For example, if the user is watching the movie “Casablanca” and starts to type a text message to a friend starting with the letters “Hum,” message composing application 430 may select and suggest the words “Humphrey Bogart.”

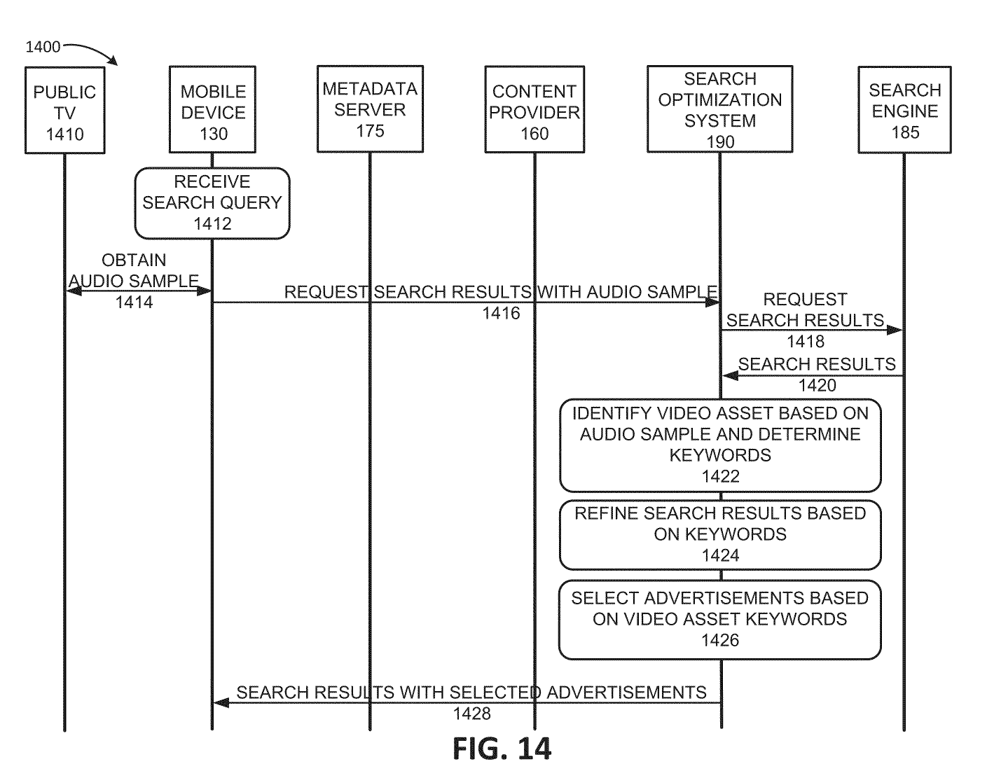

FIG. 14 is a diagram of a first exemplary scenario 1400 according to one or more implementations described herein. In scenario 1400, mobile device 130 may detect a public television playing in the vicinity, may identify a video asset being played, and may modify a search based on the identified video asset. Scenario 1400 may include receiving a search query (block 1412). For example, the user may activate search bar 1020 while waiting in a reception area. The reception area may include public television (TV) 1410 that is playing a television show. Mobile device 130 may detect public TV 1410 and may obtain an audio sample (signal 1414). The audio sample may be obtained before the user activates search bar 1020. The user may enter a search query and the search query may be sent to search optimization system 190 along with the obtained audio sample (signal 1416).

Search optimization system 190 may use the search query to request search results from search engine 185 (signal 1418) and search engine 185 may return the search results to search optimization system 190 (signal 1420). Search optimization system 190 may identify the video asset being played by public TV 1410 by analyzing the obtained audio sample and by matching the obtained audio sample to a particular video asset in video asset DB 510. After identifying the video asset, search optimization system 190 may select a list of keywords associated with the video asset (block 1422). The selected list of keywords may be used to refine the search results (block 1424). For example, the search results may be ranked based on relevance to the selected list of keywords. Furthermore, search optimization system 190 may select advertisements based on the selected list of keywords (block 1426) and the modified search results and the selected advertisements may be sent to mobile device 130 (signal 1428).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with respect to FIGS. 6-9, and a series of signal flows have been described with respect to FIGS. 11-14, the order of the blocks and/or signals may be modified in other implementations. Further, non-dependent blocks and/or signals may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

The term “logic,” as used herein, may refer to a combination of one or more processors configured to execute instructions stored in one or more memory devices, may refer to hardwired circuitry, and/or may refer to a combination thereof. Furthermore, a logic may be included in a single device or may be distributed across multiple, and possibly remote, devices.

For the purposes of describing and defining the present invention, it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method, performed by a computer device, the method comprising:
receiving, by the computer device, a search query from a second screen device;
determining, by the computer device, that a video asset is being streamed to a first screen device associated with the second screen device;
modifying, by the computer device, the search query based on one or more keywords associated with the video asset, based on determining that the video asset is being streamed to the first screen device;
obtaining, by the computer device, search results based on the modified search query; and
providing, by the computer device, the obtained search results to the second screen device.

2. The method of claim 1, wherein modifying the search query based on one or more keywords associated with the video asset includes:
sending a list of keywords associated with the video asset to the second screen device;
receiving, from the second screen device, a selection of at least one keyword from the sent list of keywords; and
adding the selected at least one keyword to the search query.

3. The method of claim 1, wherein modifying the search query based on one or more keywords associated with the video asset includes:
determining that a particular keyword, included in the received search query, is classified in multiple categories; and
selecting a particular one of the multiple categories for the particular keyword based on the video asset.

4. The method of claim 1, wherein modifying the search query based on one or more keywords associated with the video asset includes:
determining that a particular keyword, included in the received search query, is associated with a refinement keyword associated with the video asset; and
replacing the particular keyword with the refinement keyword.

5. The method of claim 1, further comprising:
determining a current video segment of the video asset being streamed to the first screen device; and
selecting the one or more keywords based on the current video segment.

6. The method of claim 1, further comprising:
selecting one or more advertisements based on the one or more keywords associated with the video asset; and
providing the one or more advertisements to the second screen device in connection with the obtained search results.

7. The method of claim 1, further comprising:
modifying the search results based on a measure of relevance to the video asset.

8. The method of claim 1, further comprising:
determining the one or more keywords associated with the video asset based on at least one of:
metadata associated with the video asset;
historical search data associated with the video asset;
web pages associated with the video asset; or
content extracted from the video asset.

9. A method, performed by a second screen device, the method comprising:
detecting, by the second screen device, that a video asset is being streamed to a first screen device associated with the second screen device;
receiving, by the second screen device, a request to execute a search query;
modifying, by the second screen device, the search query based on detecting that the video asset is being streamed to the first screen device;
obtaining, by the second screen device, search results from a search engine using the modified search query; and
presenting, by the second screen device, the obtained search results on a second screen associated with the second screen device.

10. The method of claim 9, wherein detecting that the video asset is being streamed to the first screen device associated with the second screen device includes:
instructing the first screen device to stream the video asset; and
receiving an indication from the first screen device that the video asset is being streamed to the first screen device.

11. The method of claim 9, wherein detecting that the video asset is being streamed to the first screen device associated with the second screen device includes:
detecting the first screen device; and
requesting, from the first screen device, information identifying the video asset, in response to detecting the first screen device.

12. The method of claim 9, wherein detecting that the video asset is being streamed to the first screen device associated with the second screen device includes:
detecting the first screen device;
determining that the first screen device is playing the video asset; and
capturing an audio sample from the video asset being played by the first screen device.

13. The method of claim 9, wherein modifying the search query includes:
receiving, from the search engine, a list of keywords associated with the video asset;
receiving a selection of one or more keywords from the list of keywords via an input device associated with the second screen device; and
adding the selected one or more keywords to the search query.

14. The method of claim 9, wherein modifying the search query includes:
adding information identifying the video asset to the search query.

15. The method of claim 14, further comprising:
adding information associated with a current video segment of the video asset to the search query.

16. The method of claim 9, wherein obtaining search results from a search engine using the modified search query includes:
receiving one or more advertisements in connection with the search results; and wherein presenting the obtained search results on a second screen associated with the second screen device includes:
presenting the received one or more advertisements on the second screen in connection with the obtained search results.

17. The method of claim 9, further comprising:
detecting activation of a message composition interface;
obtaining a list of keywords associated with the video asset;
modifying an auto-completion dictionary, associated with the message composition interface, based on the obtained list of keywords; and
applying the modified auto-completion dictionary to the message composition interface.

18. A computer device comprising:
logic configured to:
receive a search query from a second screen device;
determine that a video asset is being streamed to a first screen device;
modify the search query based on one or more keywords associated with the video asset, based on determining that the video asset is being streamed to the first screen device;
obtain search results based on the modified search query; and
provide the obtained search results to the second screen device.

19. The computer device of claim 18, wherein, when modifying the search query based on one or more keywords associated with the video asset, the logic is further configured to:
send a list of keywords associated with the video asset to the second screen device;
receive, from the second screen device, a selection of at least one keyword from the sent list of keywords; and
add the selected at least one keyword to the search query.

20. The computer device of claim 18, wherein the logic is further configured to determine the one or more keywords associated with the video asset based on at least one of:
metadata associated with the video asset;
historical search data associated with the video asset;
web pages associated with the video asset; or
content extracted from the video asset.
